(19) United States
(12) Patent Application Publication
(10) Pub. No.: US 2010/0026580 A1
(43) Pub. Date: Feb. 4, 2010

(54) PIFA antenna design method

(75) Inventor: Chia-Lun Tang, Pa-Te City (TW)

Correspondence Address: BIRCH STEWART KOLASCH & BIRCH, PO BOX 747, FALLS CHURCH, VA, 22040-0747, US

(73) Assignee: AUDEN TECHNO CORP.

(21) Appl. No.: 12/219,980

(22) Filed: Jul. 31, 2008

(51) Int. Cl. H01Q 1/38

(52) U.S. Cl. 343/700 MS

(57) ABSTRACT

A planar inverted-F antenna design method for designing a planar inverted-F antenna having excellent hearing aid compatibility is disclosed to include the step of setting the position of the feed leg and short-circuit leg for planar inverted-F antenna to be within 10 cm from the center of one short side of the circuit board along the direction of the corresponding short side of the circuit board, and the step of designing the shape of the planar inverted-F antenna.

### BACKGROUND OF THE INVENTION

1. Field of the Invention

The present invention relates to antenna technology and more particularly, to a planar inverted-F antenna design method for designing a planar inverted-F antenna that improves hearing aid compatibility.

2. Description of the Related Art

A typical PIFA antenna (planar inverted-F antenna) includes four parts, namely, the radiating surface, the feed-in means, the short-circuit means and the grounding surface. For the advantages of small-sized characteristics, PIFA antennas are inventively used in mobile telephones.

When a digital cellular telephone and a hearing aid are in operation at the same time, the microphone or communication coil may receive the pulse energy of the electromagnetic field produced around the antenna of the cellular telephone, causing interference. At this time, the hearing aid user will hear a noise of sizzling sound. ANSI (American National Standards Institute) defines ANSI C63.19, establishing compatibility between hearing aids and cellular telephones. FCC (Federal Communications Commission) enforces: By Feb. 18, 2008, mobile phone manufacturers and service providers will have to ensure that at least 50% of all handsets marketed in the U.S. meet the requirements of ANSI C63.19:2006, Methods of Measurement of Compatibility between Wireless Communications Devices and Hearing Aids.

ANSI C63.19 defines the hearing aid compatibility test standard as:

a. use a test probe to measure the electromagnetic field quantity within the area of 5×5 cm at 15 mm above the acoustic output.

b. divide the test plane into 9 blocks and measure the maximum electromagnetic field strength of every block.

c. define HDC rating based on the maximum electromagnetic field strength among the 9 blocks.

d. establish HAC rating using 5 dB as the threshold, to be M1, M2, M3, M4 (in which M3 and M4 meet the requirements).

Therefore, we normally observe the HAC rating of electric field and magnetic field, and then use the poorest rating to define HAC value at that frequency.

FIG. 1 illustrates the distribution of the 9 blocks S during a HAC test on a regular cellular telephone 1. As illustrated, the 9 blocks S are spread along the vertical center line L1 and horizontal line L2 of the acoustic output.

Therefore, it is desirable to provide a planar inverted-F antenna design method for designing a planar inverted-F antenna having excellent hearing aid compatibility.

### SUMMARY OF THE INVENTION

The present invention has been accomplished under the circumstances in view. It is main object of the present invention to provide a planar inverted-F antenna design method for designing a planar inverted-F antenna that has excellent hearing aid compatibility. To achieve this and other objects of the present invention, the planar inverted-F antenna design method is at first to set the position of the feed leg and short-circuit leg for planar inverted-F antenna to be within 10 cm from the center of one short side of the circuit board along the direction of the corresponding short side of the circuit board, and then to design the shape of the planar inverted-F antenna. A planar inverted-F antenna subject to this design has excellent hearing aid compatibility, meeting ANSI C63.19 requirements.

The design principle of the present invention is based on the general cavity theory for planar antenna in which a short circuit structure can be utilized in the design of a planar inverted-F antenna to have the electric field at the short-circuit point be zeroed. By means of controlling the lowest part of the antenna electric field to be at the border of the circuit board and the major part of the antenna electric field to be far from the border of the circuit board or the center of the HAC test plane, the extension of the grounding surface of the circuit board is utilized to reduce HAC test electric field value.

### BRIEF DESCRIPTION OF THE DRAWINGS

FIG. 1 is a schematic drawing showing the spread of 9 HAC test blocks on a regular cellular telephone.

FIG. 2 is a flow chart of a planar inverted-F antenna design method according to the present invention.

FIG. 3 is a plain view showing a planar inverted-F antenna designed according to the present invention.

FIG. 3A is an elevational view of FIG. 3.

FIG. 4 is a plain view showing a first example of planar inverted-F antenna according to the present invention.

FIG. 4A is a HAC test E-field distribution diagram of the first example of planar inverted-F antenna according to the present invention.

FIG. 4B is a HAC test H-field distribution diagram of the first example of planar inverted-F antenna according to the present invention.

FIG. 5 is a plain view showing a second example of planar inverted-F antenna according to the present invention.

FIG. 5A is a HAC test E-field distribution diagram of the second example of planar inverted-F antenna according to the present invention.

FIG. 5B is a HAC test H-field distribution diagram of the second example of planar inverted-F antenna according to the present invention.

FIG. 6 is a plain view showing a third example of planar inverted-F antenna according to the present invention.

FIG. 6A is a HAC test E-field distribution diagram of the third example of planar inverted-F antenna according to the present invention.

FIG. 6B is a HAC test H-field distribution diagram of the third example of planar inverted-F antenna according to the present invention.

FIG. 7 is a plain view showing a fourth example of planar inverted-F antenna according to the present invention.

FIG. 7A is a HAC test E-field distribution diagram of the fourth example of planar inverted-F antenna according to the present invention.

FIG. 7B is a HAC test H-field distribution diagram of the fourth example of planar inverted-F antenna according to the present invention.

FIG. 8 is a plain view showing a fifth example of planar inverted-F antenna according to the present invention.

FIG. 8A is a HAC test E-field distribution diagram of the fifth example of planar inverted-F antenna according to the present invention.

FIG. 8B is a HAC test H-field distribution diagram of the fifth example of planar inverted-F antenna according to the present invention.

FIG. 9 is a plain view showing a sixth example of planar inverted-F antenna according to the present invention.

FIG. 9A is a HAC test E-field distribution diagram of the sixth example of planar inverted-F antenna according to the present invention.

FIG. 9B is a HAC test H-field distribution diagram of the sixth example of planar inverted-F antenna according to the present invention.

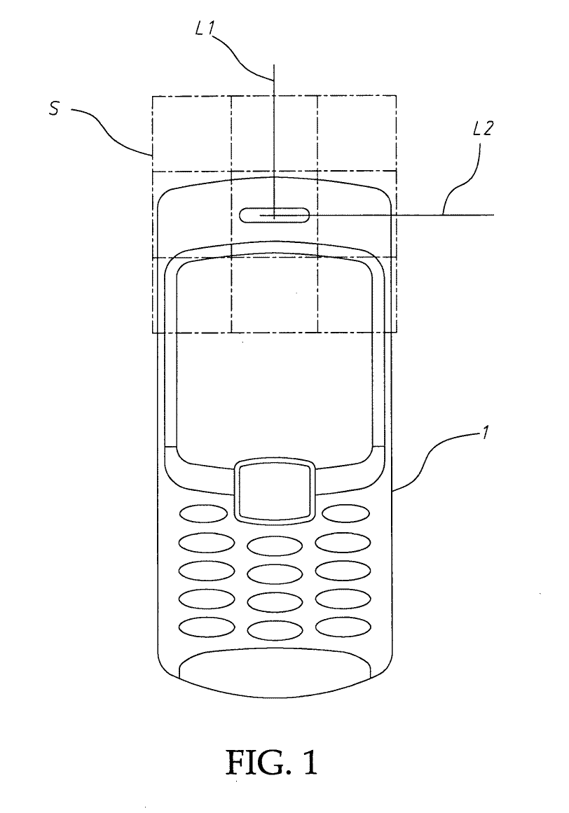

### DETAILED DESCRIPTION OF THE PREFERRED EMBODIMENT

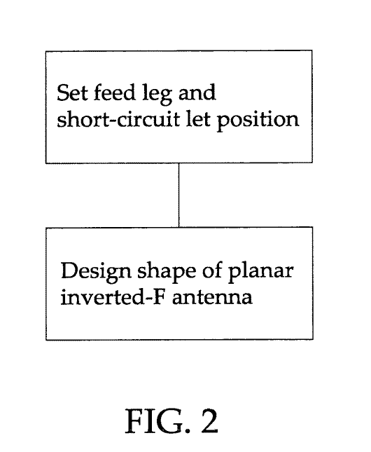

Referring to FIG. 2, the invention provides a planar inverted-F antenna design method for designing a planar inverted-F antenna having excellent hearing aid compatibility. This design method includes the steps of:

1) set the position of the feed leg and short-circuit leg to be within 10 mm from the center of one short side of the circuit board for cellular telephone;

2) design the shape of the planar inverted-F antenna.

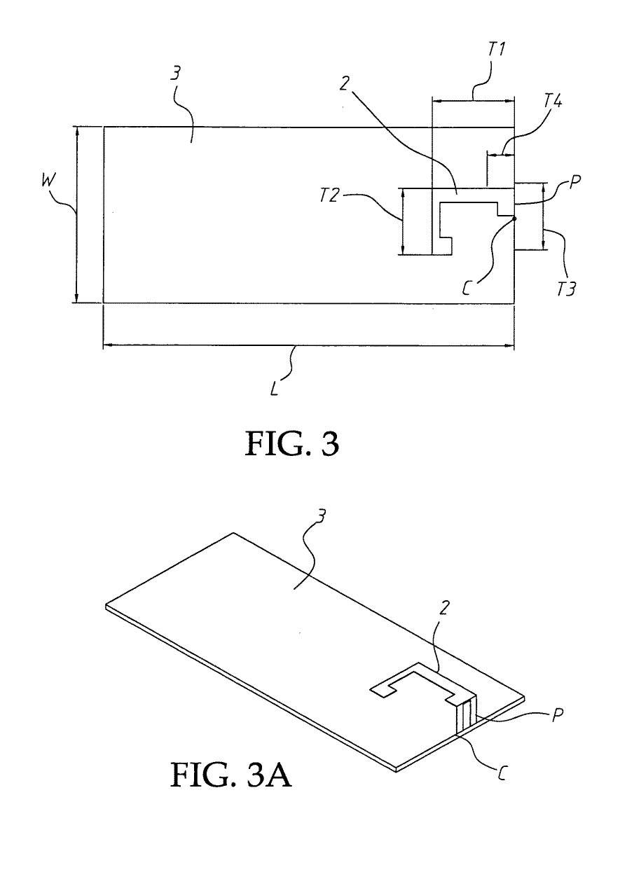

FIGS. 3 and 3A illustrate a planar inverted-F antenna 2 designed according to the present invention, in which the circuit board 3 has a length L 100 mm and a width W 40 mm; the planar inverted-F antenna 2 has a length T1 20 mm and a width T2 15 mm; the position P of the feed leg and short-circuit leg is defined to be within the space T3 10 mm from the center C of one short side of the circuit board 3 in either of the two reversed directions along the corresponding short side; preferably, the position P of the feed leg and short-circuit leg is within the distance T4 that extends 5 mm from the border of the corresponding short side in direction along the length of the circuit board 3.

Comparing the design shown in FIGS. 3 and 3A with other designs in which the position of the feed leg and short-circuit leg of the antenna is shifted along one short side of the circuit board shows HAC changes.

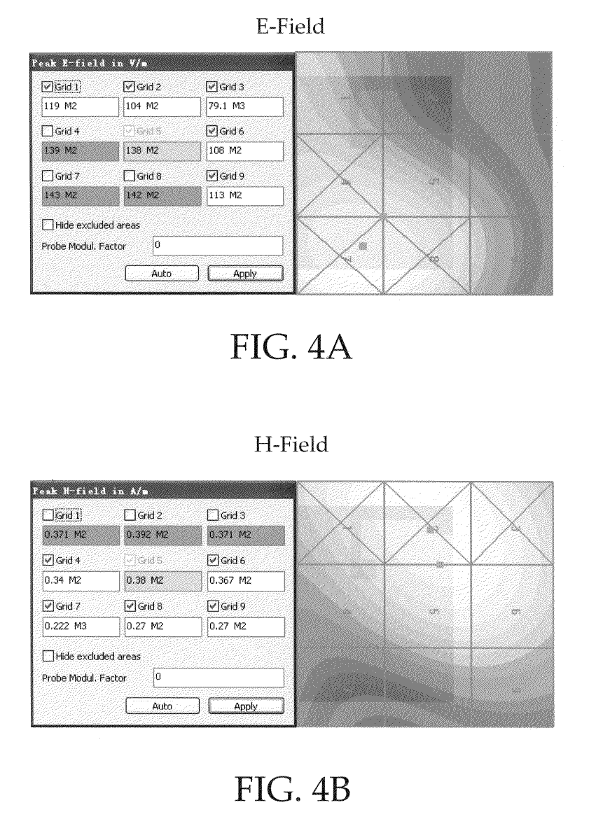

According to Example I shown in FIG. 4, the position P1 of the feed leg and short-circuit leg of the planar inverted-F antenna 21 is located on one end of one short side of the circuit board 3. FIG. 4A shows the HAC test electric field distribution of Example I as follows:

| | | | Total | Radiation | Matching |
|---|---|---|---|---|---|
| | Directional | Gain | efficiency | efficiency | efficiency |
| Frequency | (dBi) | (dBi) | (%) | (%) | (%) |
| 1900 MHz | 4.40883 | 4.31587 | 95.1788 | 97.3154 | 97.8045 |

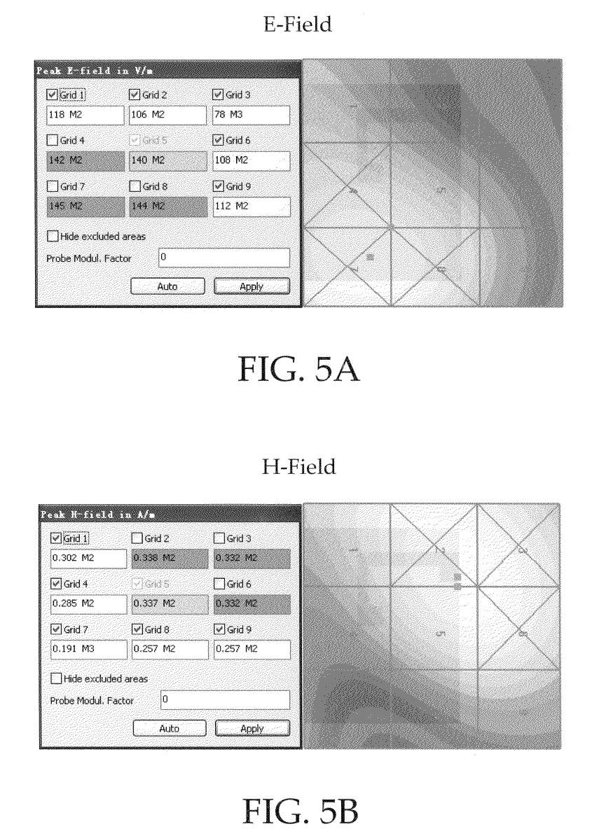

According to Example II shown in FIG. 5, the position P2 of the feed leg and short-circuit leg of the planar inverted-F antenna 22 is located on one short side of the circuit board 3 at a distance A2 that is 5 mm from one end of the corresponding short side. FIG. 5A shows the HAC test electric field distribution of Example II as follows:

| | | | Total | Radiation | Matching |
|---|---|---|---|---|---|
| | Directional | Gain | efficiency | efficiency | efficiency |
| Frequency | (dBi) | (dBi) | (%) | (%) | (%) |
| 1900 MHz | 4.48817 | 4.32435 | 87.2193 | 97.3387 | 89.6039 |

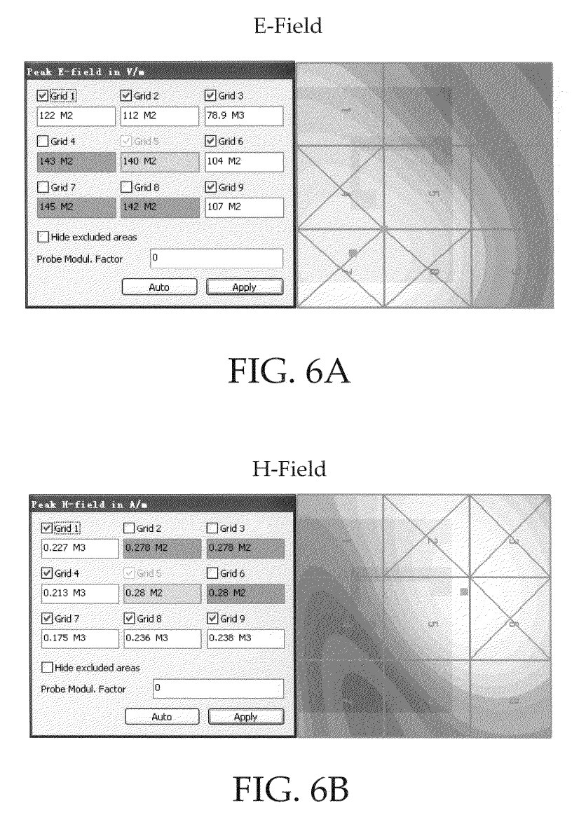

According to Example III shown in FIG. 6, the position P3 of the feed leg and short-circuit leg of the planar inverted-F antenna 23 is located on one short side of the circuit board 3 at a distance A3 that is 10 mm from one end of the corresponding short side. FIG. 6A shows the HAC test electric field distribution of this Example III as follows:

| | | | Total | Radiation | Matching |
|---|---|---|---|---|---|
| | Directional | Gain | efficiency | efficiency | efficiency |
| Frequency | (dBi) | (dBi) | (%) | (%) | (%) |
| 1900 MHz | 4.46059 | 4.34168 | 71.8776 | 97.4127 | 73.7867 |

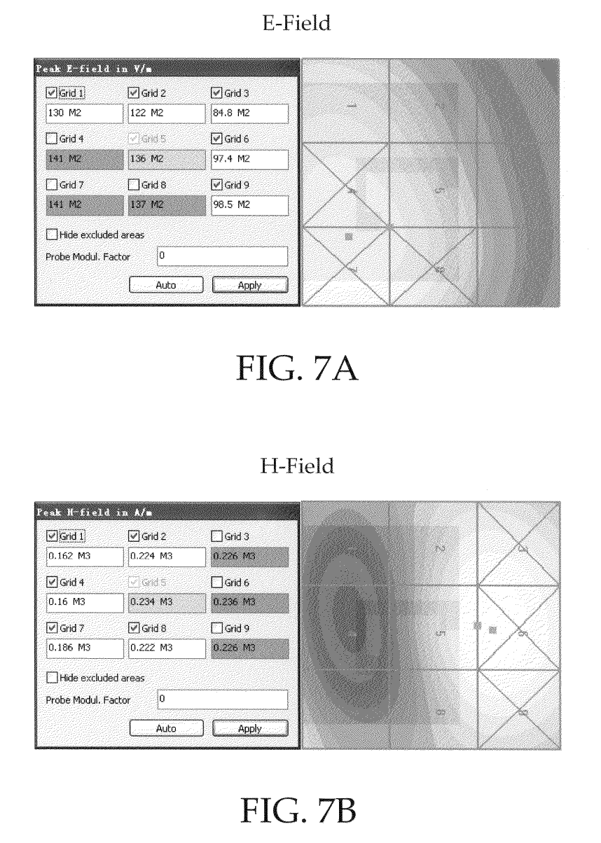

According to the Example IV shown in FIG. 7, the position P4 of the feed leg and short-circuit leg of the planar inverted-F antenna 24 is located on one short side of the circuit board 3 at a distance A4 that is 15 mm from one end of the corresponding short side. FIG. 7A shows the HAC test electric field distribution of this Example IV as follows:

| | | | Total | Radiation | Matching |
|---|---|---|---|---|---|
| | Directional | Gain | efficiency | efficiency | efficiency |
| Frequency | (dBi) | (dBi) | (%) | (%) | (%) |
| 1900 MHz | 4.35046 | 4.29146 | 63.4314 | 97.4324 | 65.103 |

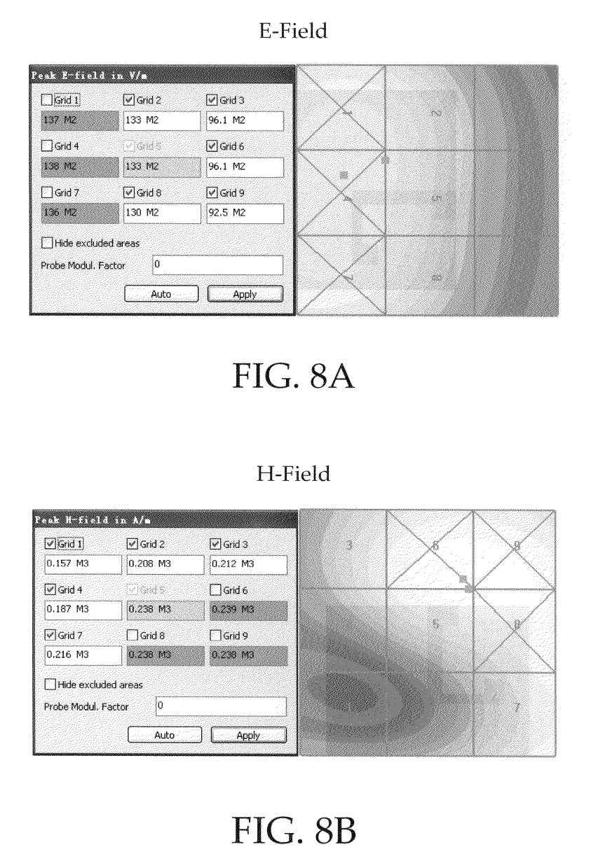

According to Example V shown in FIG. 8, the position P5 of the feed leg and short-circuit leg of the planar inverted-F antenna 25 is located on one short side of the circuit board 3 at a distance A5 that is 20 mm from one end of the corresponding short side. FIG. 8A shows the HAC test electric field distribution of this Example V as follows:

| | | | Total | Radiation | Matching |
|---|---|---|---|---|---|
| | Directional | Gain | efficiency | efficiency | efficiency |
| Frequency | (dBi) | (dBi) | (%) | (%) | (%) |
| 1900 MHz | 4.3402 | 4.2864 | 68.5899 | 97.3715 | 70.4415 |

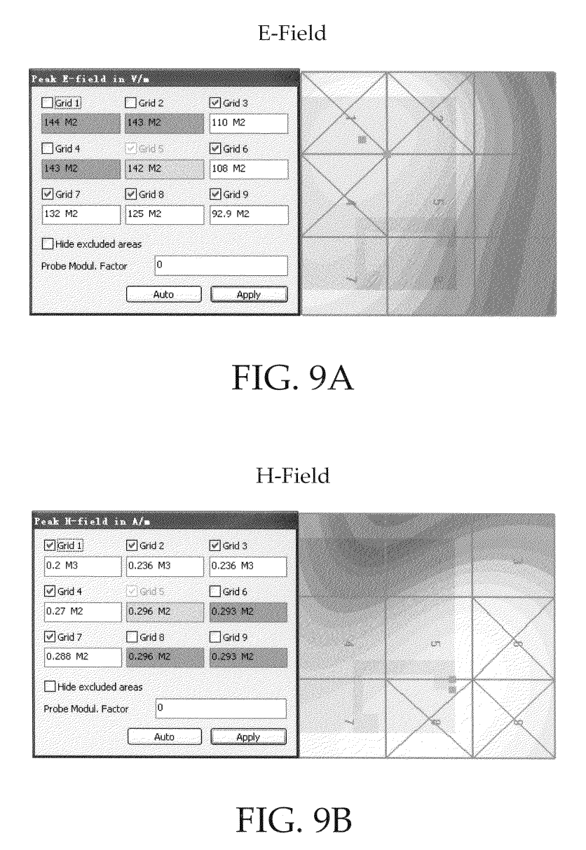

According to the example VI shown in FIG. 9, the position P6 of the feed leg and short-circuit leg of the planar inverted-F antenna 26 is located on one short side of the circuit board 3 at a distance A6 that is 25 mm from one end of the corresponding short side. FIG. 9A shows the HAC test electric field distribution of this example VI as follows:

| | | | Total | Radiation | Matching |
|---|---|---|---|---|---|
| | Directional | Gain | efficiency | efficiency | efficiency |
| Frequency | (dBi) | (dBi) | (%) | (%) | (%) |
| 1900 MHz | 4.33921 | 4.2864 | 64.239 | 97.2415 | 66.0613 |

From the aforesaid 6 embodiments, we obtain the following conclusions as follows:

| | Distance of antenna feed leg | | |
|---|---|---|---|
| | and short-circuit leg position | HAC | |
| Example | from long side (mm) | E-field (v/m) | H-field (A/m) |
| CASE 1 | 0 | 138 | 0.38 |
| CASE 2 | 5 | 140 | 0.377 |
| CASE 3 | 10 | 140 | 0.28 |
| CASE 4 | 15 | 136 | 0.234 |
| CASE 5 | 20 | 133 | 0.238 |
| CASE 6 | 25 | 142 | 0.296 |

As stated, under the same TRP (total radiated power about 28 dBm), when shifting the short-circuit leg and feed leg of the antenna along the short side of the circuit board, is shows less HAC variation in electric field but great variation in H-field. The optimal position is about within 10 mm from the center of the short side.

Subject to the general cavity theory for planar antenna, a short circuit structure can be utilized in the design of a planar inverted-F antenna to have the electric field at the short-circuit point be zeroed. By means of controlling the lowest part of the antenna electric field to be at the border of the circuit board and the major part of the antenna electric field to be far from the border of the circuit board or the center of the HAC test plane, the extension of the grounding surface of the circuit board is utilized to reduce HAC test electric field value.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A planar inverted-F antenna design method, comprising the steps of:
a) setting the position of the feed leg and short-circuit leg for planar inverted-F antenna to be within a predetermined distance from the center of one short side of the circuit board;
b) designing the shape of the planar inverted-F antenna.

2. The planar inverted-F antenna design method as claimed in claim 1, wherein the position of the feed leg and short-circuit leg for planar inverted-F antenna is set to be within 10 cm from the center of the corresponding short side of the circuit board in each of the two reversed directions along the corresponding short side.

3. The planar inverted-F antenna design method as claimed in claim 2, wherein the position of the feed leg and short-circuit leg for planar inverted-F antenna is set to be within 5 cm from the border of the corresponding short side of the circuit board in direction along the length of the circuit board.
